(19) United States
(12) Patent Application Publication
(10) Pub. No.: US 2005/0209882 A1
(43) Pub. Date: Sep. 22, 2005

(54) Clinical data processing system

(76) Inventors: Jeffry Brent Jacobsen, Logan, UT (US); Rex Wendell Maughan, Murray, UT (US)

Correspondence Address: Alexander J. Burke;Intellectual Property Department, 5th Floor, 170 Wood Avenue South, Iselin, NJ, 08830, US

(21) Appl. No.: 10/901,273

(22) Filed: Jul. 28, 2004

Related U.S. Application Data
(60) Provisional application No. 60/555,219, filed on Mar. 22, 2004.

(51) Int. Cl. G06F 17/60

(52) U.S. Cl. 705/2

(57) ABSTRACT

A system for use in processing clinical data includes an input processor for receiving user identification information. A display generator initiates generation of data representing an image for display including, an item of clinical data of a particular patient and an image element enabling a user to enter data identifying a clinical significance ranking of the item of clinical data. A data processor associates the user with an entered clinical significance ranking of the item of clinical data and with the clinical data item. A storage processor stores, in a repository, information indicating the entered clinical significance ranking of the item of clinical data and the associated clinical data item and user.

This is a non-provisional application of provisional application Ser. No. 60/555,219 by Jeffry Brent Jacobsen et al. filed Mar. 22, 2004.

### FIELD OF THE INVENTION

This invention concerns a system for processing and ranking clinical data including patient results, observations, progress notes and assessments, for example.

### BACKGROUND OF THE INVENTION

Existing systems are limited in their ability to determine the clinical relevance of information stored in electronic patient records. The existing systems typically do this by using data analysis and expert systems employing rules to determine the clinical significance of the data. These rules implement methods involving identifying data patterns and link the results to attempt to indicate the clinical relevance of individual pieces of information. In existing systems it is difficult to establish rules that successfully identify clinically significant data based on the content of the data. Existing systems attempt to create rules to determine the clinical significance of data based on information acquired from experts, for example. Unfortunately, these rules fail to consistently determine clinical relevance of medical information from a variety of different sources including different patient records.

The difficulty of determining clinical relevance of medical information is compounded by the fact that otherwise normal patient medical results (data) may become clinically significant based on a specific patient medical condition, for example. In other cases, apparently abnormal patient medical data may simply be normal for a particular individual patient. As a result of these patient specific medical data variations, existing generalized expert systems fail to consistently and accurately predict the clinical significance of clinical data in a variety of patient cases. Further, the rules employed by existing systems result in either the identification of data as significant that is not significant or the mis-identification of clinically significant data as being insignificant. Individual clinical providers also have different opinions about what qualifies as clinically significant and what does not. In some cases, it is even difficult for experts to agree on clinical significance of specific items. A system according to invention principles addresses these problems and related problems.

### SUMMARY OF THE INVENTION

A system employs a combination of human and automated processing functions to determine clinical significance of individual clinical results, observations, progress notes and assessments, for example. A system for use in processing clinical data, includes a display generator for initiating generation of data representing an image for display including, an item of clinical data of a particular patient and an image element enabling a user to enter data identifying a clinical significance ranking of the item of clinical data. The system also includes at least one repository incorporating information associating data identifying a user with an entered clinical significance ranking of the item of clinical data and with the clinical data item.

### BRIEF DESCRIPTION OF THE DRAWING

FIG. 1 shows a system for use in processing clinical data and accompanying clinical significance ranking information, according to invention principles.

FIG. 2 shows a user interface display image supporting user entry and association of a clinical data significance ranking with a clinical data item, according to invention principles.

FIG. 3 shows a system for acquiring, processing and distributing clinical data significance ranking information and associated clinical data, according to invention principles.

FIG. 4 shows a flowchart of a process for predicting, acquiring and processing clinical data significance ranking information and associated clinical data, according to invention principles.

### DETAILED DESCRIPTION OF INVENTION

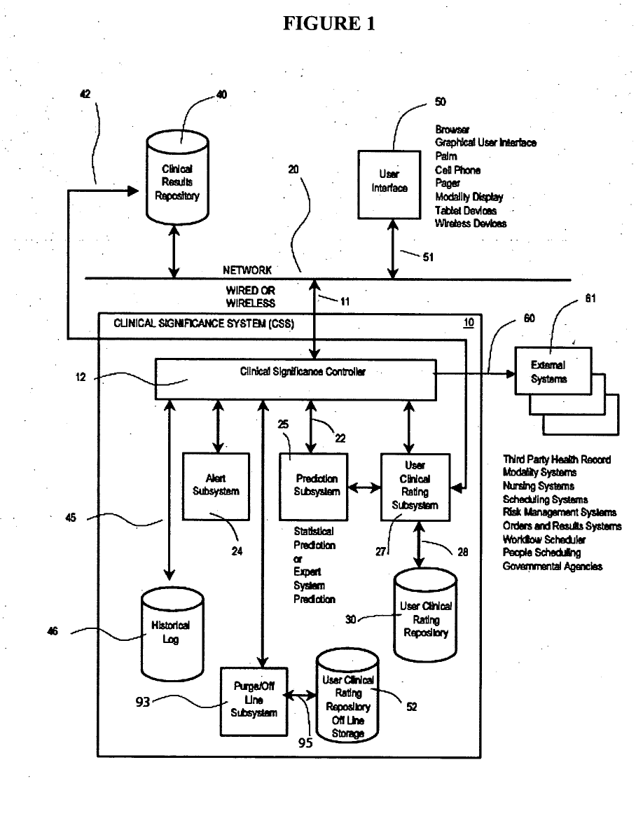

FIG. 1 shows a system for use in processing clinical data and accompanying clinical significance ranking information. Existing systems create rules to determine clinical significance of a clinical data item based on general information provided by experts, for example. Unfortunately, these general rules often do not work and result in an insignificant clinical data item being labeled as significant or results in a clinically significant data item being miss-labeled as insignificant. Individual clinicians also differ in opinion about what qualifies as clinically significant and what does not and in some cases, it is difficult to get clinicians to agree on clinical significance of even specific clinical data items. In order to accommodate these limitations and clinician variability while still providing the assistance of computerized systems, a combination of human and processing functions are employed in one embodiment of the system.

The system provides a method for determining the clinical significance of individual clinical results, observations, progress notes and assessments, for example, that accommodates human limitations and patient variability. In one embodiment the system employs a combination of human and automated processing functions and is applicable in processing and storing clinical information. The system captures and rates clinical significance of patient related data and employs a significance data repository that provides input for expert systems and statistical analysis that enables continuous improvement in the quality and predictability of computer generated clinical significance ratings. The system provides a user interface that facilitates acquisition of clinical relevance information about individual pieces of clinical data by offering the clinical user the opportunity to rate the significance of the data. The user is not required to identify the significance of every piece of clinical data as previously entered clinical data significance ranking information is used in predicting the clinical relevance of a particular clinical data item.

As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display generator is a known element comprising electronic circuitry or software or a combination of both for generating display images or portions thereof.

In the FIG. 1 system, in response to display of a clinical data item (such as a laboratory test result of a patient) to a user via user interface 50, clinical significance system 10 provides a clinical significance ranking (CSR) of the clinical data item. Specifically, User Clinical Ranking Subsystem 27 retrieves from CSR repository 30 using bidirectional communication interface 28, a clinical significance ranking (CSR) of the clinical data item displayed via interface 50, if one has been previously assigned. Controller 12 in conjunction with subsystem 27 initiates display of the retrieved CSR to a user via user interface 50. If the current user is the user who previously assigned the CSR that is retrieved from repository 30 to the clinical data item, system 10 allows the user to modify the CSR and store the replaced CSR in Historical Log 46. If the user is not the user who previously assigned the clinical data item CSR that is retrieved from repository 30, or if no ranking has been assigned, and if the user is authorized to assign a CSR, system 10 enables the user to enter a ranking and store it in repository 30.

In the exemplary embodiment, CSR Repository 30 is implemented as a separate database, or in another embodiment it may be implemented by adding a field (or fields) to Clinical Results Repository 40 or to one or more distributed databases accessed via network 20. In this other embodiment, access to Clinical Results Repository 40 is supported using bidirectional communication interface 42 and this embodiment may omit CSR repository 30 and interface 28. Repository 30 incorporates CSR data that includes a clinical significance ranking of an individual clinical data item and also an indicator identifying whether a CSR has been made for an individual clinical data item. This data is stored in CSR repository 30 but alternatively may be stored in Clinical Results Repository 40. The CSR scale of a clinical data item is determinable by a user via an option selection list or other user interface menu item and may include selectable options as simple as “Yes—This is significant, No—This is not significant”. Other options may comprise a categorization such as a simple ‘Yes’, ‘No’ or ‘Not Sure’ rankings or “Very Significant”, “Intermediately Significant” or “Not Significant”, for example. The selectable clinical significance ranking may also be based on a scale such as 1-4,0-9, etc.

The value that is used for most significant and least significant rankings is also stored in CSR repository 30 (or in another repository in a different embodiment) to allow conversion from a CSR system used by one institution to that of another. If CSR repository 30 is implemented as a separate database, it also incorporates a unique index link to a specific result that is being rated. Other fields in CSR repository 30 identify a particular user that assigned the CSR as well as a time and date when the CSR was assigned, and optional data to indicate other conditions that influenced the ranking (i.e. the diagnosis code that made this ranking significant).

Optional Prediction Subsystem 25 analyzes historical data indicating combinations of clinical results and patient conditions that have been previously considered significant in order to predict the clinical significance of received data representing a patient clinical data item (including laboratory test results, for example). If statistical analysis performed by subsystem 25 shows high confidence in a prediction of a clinical significance ranking of a clinical data item, a result is indicated as potentially significant and an alert message is generated by Alert Subsystem 24 to prompt a user to review the result as soon as possible to enable the user to initiate action based on the result. Further, prediction system 25 accumulates CSR data and proposes tests or orders in response to analysis of the accumulated data, based on matching criteria in previously encountered compatible situations. The proposed tests or orders derived by prediction system 25 are provided via interface 22 to Clinical Significance Controller 12 and by controller 12 to external systems 61 via interface 60.

Alert subsystem 24, in addition to alerting users of clinical data items that may be significant based upon prediction by subsystem 25, also alerts users via User Interface 50 of clinical data items previously considered to be significant for a patient when the patient returns for a subsequent encounter, for example. Thereby subsystem 24 ensures that a clinical data item previously considered to be significant, stands out from what may be a large accumulation of clinical data, results and assessments that are normal and of no immediate interest.

As clinical data including laboratory results become older, they generally become less relevant and at some point in time it becomes necessary to archive this clinical data. This involves moving the clinical data from immediately available on demand storage to archived storage that typically requires more time to access because of a need to load removable media (such as tape, disk etc.), for example. The archive process is provided by Purge/Off Line Subsystem 93. Clinical significance system 10 including alert subsystem 24 and controller 12 and unit 93 implement the archive process based upon the ranking of the results stored in CSR repository 30 or clinical results repository 40. The archive process ensures that significant results remain active and available in repositories 30 and 40 longer than less significant results. This minimizes the need to access archived data and prioritizes the archival process.

User interface 50 is compatible with a browser application such as Microsoft Explorer or Netscape Navigator, and comprises a Graphical User Interface (GUI) for presentation on a Personal Digital Assistant (PDA), Cell Phone, Pager, Tablet device, wireless device or medical device display. User interface 50 is coupled to clinical significance controller 12 via communication interfaces 11 and 51 and through network 20. External Systems 61 obtain information from controller 12 by way of communication interface 60 which employs HealthLevel 7 (HL7) messages with extensions or alternatively employs a proprietary interface message format depending on the needs of external systems 61, for example. Further, external Systems 61 may comprise one or more of a patient medical record system, a medical device system (such an MRI, CT, X-ray, other imaging system or patient monitoring system, for example), a nursing system, scheduling system, risk management system, orders and results management system, workflow scheduler, people scheduler and Governmental agency system. External Systems 61 employ clinical significance system 10 to modify a workflow comprising a task sequence to be performed by a worker. Specifically, external Systems 61 employ clinical significance system 10 to modify a workflow in order to schedule new tests or schedule use of resources and people. Similarly, system 10 is used to modify tests to be performed using medical devices to provide results for storage in external health records or to be shared with governmental agencies such as the US Center for Disease Control.

Historical log 46 maintains a historical record indicating changes made to CSR repository 30 and that identifies a user authoring the change as well as a time and date stamp identifying time and date of a change. The historical record includes a reason for a change or a logged item. The information stored in historical log 46 is provided by controller 12 using bidirectional communication interface 45. Controller 12 receives alerts from alert subsystem 24 and generates a record identifying an alert for storage in Historical log 46. Controller 12 receives data representing a prediction made by the Prediction Subsystem 25 via interface 22 and stores the predication representative data into the Historical Log 46.

In the FIG. 1 system a clinical user is presented via user interface 50 with a clinical data item comprising a clinical result, observation, assessment, progress note or diagnosis together with an optional clinical significance ranking. The clinical user rates the significance of this clinical data item using a sliding scale (1-5, 1-10, etc.), for example. The user selected ranking may indicate how likely the clinical user is to use the information in the future. A displayed check box provides a user with an option of indicating a particular clinical data item is to be displayed as clinically relevant data when the patient concerned is seen on a subsequent occasion. System 10 stores user entered clinical significance ranking information in a data structure in repository 30 searchable by different criteria. Such different criteria include, by clinical user and by class of user. The user class is a classification of the clinical role or category of the user such as a physician, nurse, laboratory technician or radiologist, for example.

In response to acquisition of a number of clinical significance rankings from a particular clinical user, a statistical analysis of the acquired rankings is performed by controller 12 in conjunction with prediction subsystem 25. The statistical analysis is used by units 12 and 25 to provide a suggested (predicted) ranking for a particular clinical data item to the clinical user for validation. The user may either validate and accept the suggested ranking or override it with a user selected ranking. As the number of clinical significance rankings in CSR repository 30 increases, the accuracy of suggested rankings provided by prediction subsystem 25 improves. The statistical analysis and prediction performed by units 12 and 25 adaptively improves with time and increases the accuracy of suggested clinical significance rankings of clinical data items. A clinical user via interface 50 is able to access, review and update clinical significance ranking information in CSR repository 30 and thereby improve the accuracy of the stored clinical significance ranking information. A clinical user is able to access a display on interface 50 of clinical significance ranking information in CSR repository 30 in response to a search query including search criteria such as date, relevance score or type of information.

System 10 receives and processes data representing feedback from a clinical user concerning significance of a clinical data item. The feedback is processed by system 10 and used to identify exceptions to existing clinical significance ranking prediction rules. This improves the accuracy of predictions provided by unit 12 and prediction subsystem 25. Also as clinical users rank clinical data items that they review, subsequent statistical analysis identifies new unexpected combinations of medical conditions and associated clinical data that have particular clinical significance rankings. System 10 advantageously presents a user (via interface 50) with an option to indicate specific patient clinical data items or observations as permanently significant for a specific patient. This helps to ensure that clinical data presented to a user is likely to be relevant and vital to a future patient encounter and to ensure that clinical data relevant to treatment of the patient is not overlooked. Large quantities of clinical data including past observations are often accumulated for a patient and much of this clinical data has little future consequence and is merely relevant to a specific patient encounter. The system 10 function affording a user the ability to indicate specific patient clinical data items or observations as permanently significant for a specific patient advantageously enables a user to focus on clinical data of importance, ignore background information and make treatment decisions more quickly and efficiently. System 10 is also able to prioritize and select clinical data to be purged or archived.

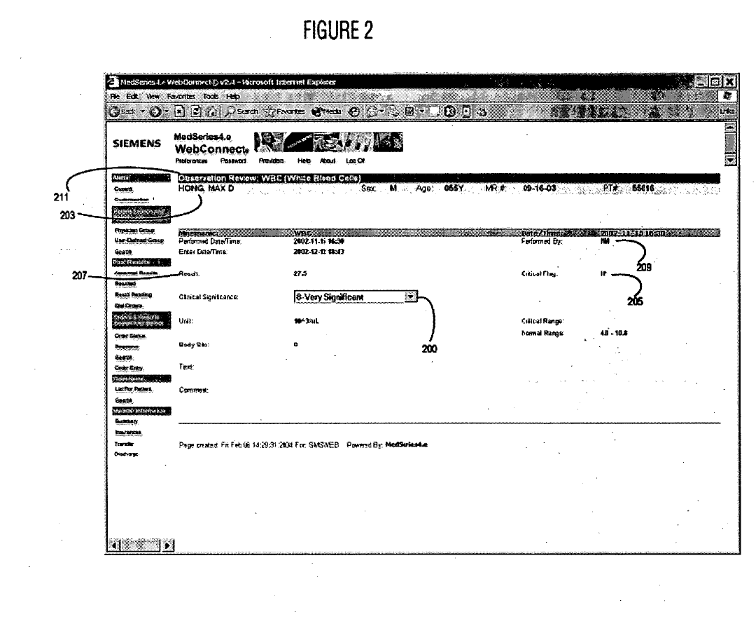

FIG. 2 shows a user interface display image supporting user entry and association of a clinical data significance ranking with a clinical data item. A user identified by item 209, associates a clinical significance ranking with a clinical data item 211 (white blood cell count) of a particular patient 203 using option list selection box 200. In this example a user selects the white blood cell count 211 with value 207 to have a “Very Significant” ranking 200 and indicates the clinical data item 211 is critical 205 and consequently to be displayed in results for this patient for subsequent encounters of the particular patient 203.

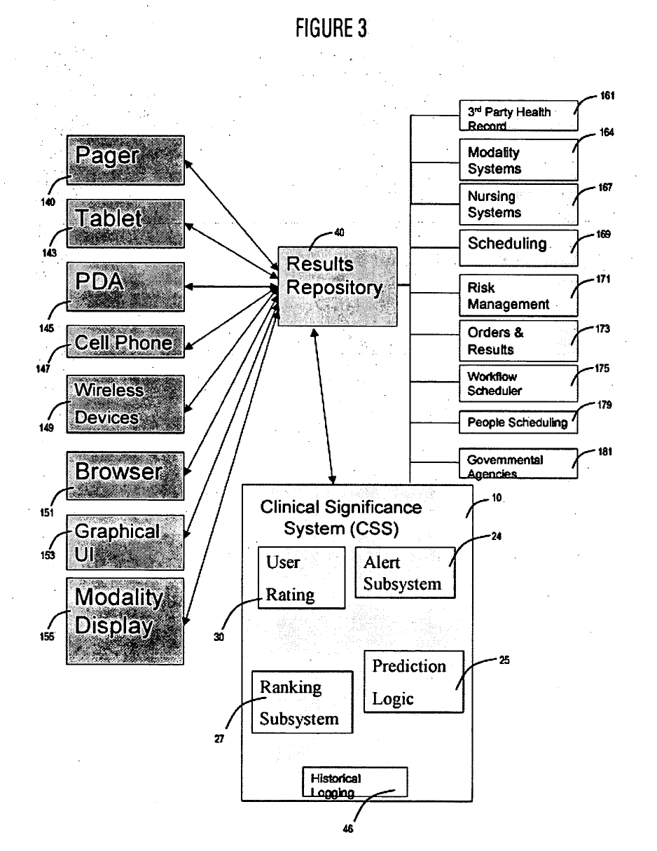

FIG. 3 shows a system for acquiring, processing and distributing clinical data significance ranking information and associated clinical data. Clinical data items in repository 40 together with associated clinical significance rankings provided by clinical significance system 10 are accessed by a user via devices 140-155 and by information systems 161-181. Devices 140-155 comprise, for example, a pager, Tablet PC, Personal Digital Assistant (PDA), cell phone, other wireless devices, a browser application or a graphical user interface executing on a processing device or a medical device such as an MRI (Magnetic Resonance Imaging) device, Computer Tomography (CT) device, X-ray or other patient monitoring, diagnosis and treatment device. Further, information systems 161-181 comprise, for example, an electronic patient record management system, a medical device management system, a nursing system, scheduling system, risk management system, orders and results system, workflow task sequencing and management system, a people (e.g., patient, physician) scheduling system, or a governmental agency system. Information systems 161-181 use the clinical data and associated clinical data significance ranking information to prioritize the clinical data concerning a patient that is displayed to a physician, laboratory technician, nurse, administrator or other healthcare worker. Information systems also use this data to alter and prioritize task sequences (workflow) for workers and systems. The systems may also use this data to generate alert messages to clinicians and others and to indicate potential medical problems or treatment problems with proposed medication orders or treatment plans, for example.

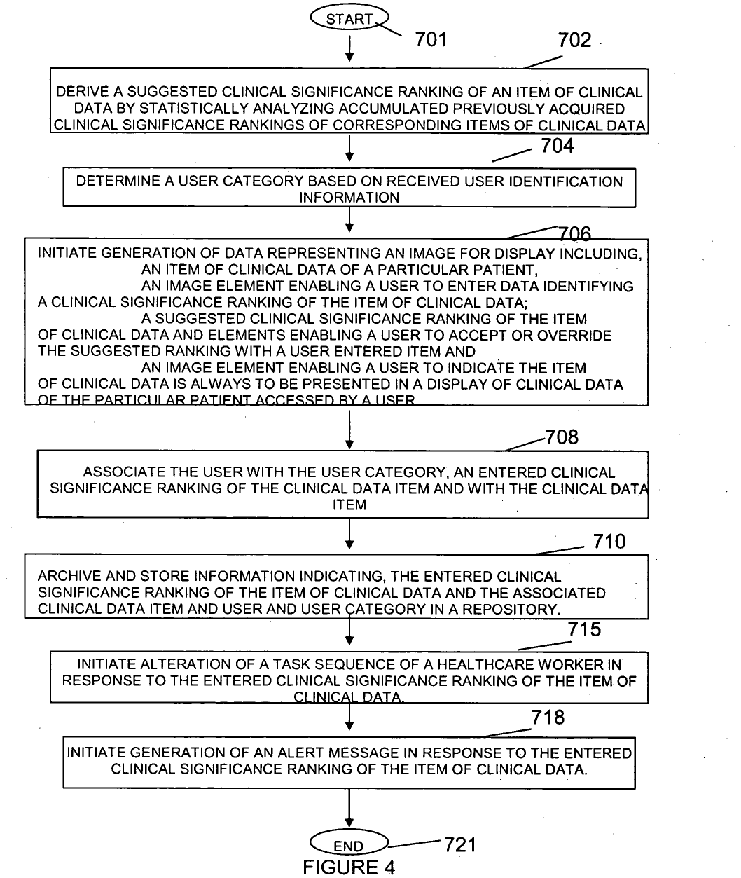

FIG. 4 shows a flowchart of a process for predicting, acquiring and processing clinical data significance ranking information and associated clinical data. In step 702 following the start at step 701, controller 12 together with prediction subsystem 25 derives a suggested clinical significance ranking of an item of clinical data based on a statistical analysis of accumulated previously acquired clinical significance rankings of corresponding items of clinical data. In step 704 clinical rating subsystem 27 determines a user category based on received user identification information. The user category comprises a category associated with one or more of, physicians, nurses, laboratory technicians, radiologists, surgeons, anesthesiologists, a physician medical specialty and pharmacist, for example. In step 706, system 10 initiates generation of data representing an image for display on user interface 50 including, an item of clinical data of a particular patient, the derived suggested clinical significance ranking of the clinical data item, an image element enabling a user to enter data identifying a clinical significance ranking of the clinical data item and an image element enabling a user to indicate the item of clinical data is always to be presented in a display of clinical data of the particular patient accessed by the user.

In step 708, controller 12 in conjunction with clinical rating subsystem 27, associates a user (i.e., user identification information) with the determined user category, the item of clinical data of the particular patient and the user entered clinical significance ranking of the clinical data item (either the derived suggested ranking or a user input ranking). In step 710, controller 12 stores the user identification information and associated user category as well as data identifying the item of clinical data of the particular patient and the associated clinical significance ranking, in CSR repository 30. Controller 12 in conjunction with purge subsystem 93 archives a clinical data item and associated ranking information in CSR repository 30 by transferring the information to archival storage in repository 52 via bidirectional interface 95. Information is archived based on a priority derived from a CSR value. Controller 12, in step 715, communicates a message via network 20 to initiate alteration of a task sequence of a healthcare worker in response to the entered clinical significance ranking of the item of clinical data. In step 718, controller 12 communicates a message via network 20 to initiate generation of an alert message in response to the entered clinical significance ranking of the item of clinical data. The process of FIG. 4 terminates at step 721.

The system and processes presented in FIGS. 1-4 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by system 10 (FIG. 1) may be implemented in hardware, software or a combination of both.

1. A system for use in processing clinical data, comprising:
a display generator for initiating generation of data representing an image for display including,
an item of clinical data of a particular patient and
an image element enabling a user to enter data identifying a clinical significance ranking of said item of clinical data; and
at least one repository incorporating information associating data identifying a user with an entered clinical significance ranking of said item of clinical data and with said clinical data item.

2. A system for use in processing clinical data, comprising:
an input processor for receiving user identification information;
a display generator for initiating generation of data representing an image for display including,
an item of clinical data of a particular patient and
an image element enabling a user to enter data identifying a clinical significance ranking of said item of clinical data;
a data processor for associating said user with an entered clinical significance ranking of said item of clinical data and with said clinical data item; and
a storage processor for storing, in a repository, information indicating said entered clinical significance ranking of said item of clinical data and said associated clinical data item and user.

3. A system according to claim 2, wherein
said data processor determines a user category based on received user identification information and associates said user category with said entered clinical significance ranking of said item of clinical data and with said clinical data item; and
said storage processor stores, in said repository, information indicating said entered clinical significance ranking of said item of clinical data and said associated clinical data item and said user category.

4. A system according to claim 3, wherein
said user category comprises a category associated with at least one of,
(a) physicians, (b) nurses, (c) laboratory technicians, (d) radiologists, (e) surgeons, (f) anesthesiologists, (g) a physician medical specialty and (h) pharmacist.

5. A system according to claim 2, wherein
said image for display includes a suggested clinical significance ranking of said item of clinical data and enables a user to at least one of, (a) accept and (b) override said suggested clinical significance ranking with a user entered item.

6. A system according to claim 5, wherein
said data processor derives said suggested clinical significance ranking of said item of clinical data from statistical analysis of a plurality of previously acquired clinical significance rankings of corresponding items of clinical data.

7. A system according to claim 2, wherein
said data processor initiates generation of an alert message in response to said entered clinical significance ranking of said item of clinical data.

8. A system according to claim 2, wherein
said data processor initiates alteration of a task sequence of a healthcare worker in response to said entered clinical significance ranking of said item of clinical data.

9. A system according to claim 2, wherein
said data processor initiates archiving of said item of clinical data in response to said entered clinical significance ranking of said item of clinical data.

10. A system according to claim 2, wherein
said data processor initiates presentation of said item of clinical data in display images concerning said particular patient in response to said entered clinical significance ranking of said item of clinical data.

11. A system according to claim 2, wherein
said image for display enables a user to indicate said item of clinical data is always to be presented in a display of clinical data of said particular patient accessed by a user.

12. A system according to claim 2, wherein
said data processor associates user identification information with said entered clinical significance ranking of said item of clinical data and with said clinical data item; and
said storage processor stores, in said repository, information indicating said entered clinical significance ranking of said item of clinical data and said associated clinical data item and said user identification information.

13. A system for use in processing clinical data, comprising:
a display generator for initiating generation of data representing an image for display including,
an item of clinical data of a particular patient and
an image element enabling a user to enter data identifying a clinical significance ranking of said item of clinical data;
a data processor for determining a user category based on said user identification information and for associating said user category with an entered clinical significance ranking of said item of clinical data and with said clinical data item; and
a storage processor for storing, in a repository, information indicating said entered clinical significance ranking of said item of clinical data and said associated clinical data item and user category.

14. A system for use in processing clinical data, comprising:
a display generator for initiating generation of data representing an image for display including,
an item of clinical data of a particular patient and
an image element enabling a user to enter data identifying a clinical significance ranking of said item of clinical data;
at least one repository incorporating information associating data identifying a user with an entered clinical significance ranking of said item of clinical data and with said clinical data item; and
a data processor for initiating alteration of a task sequence of a healthcare worker in response to said entered clinical significance ranking of said item of clinical data.

15. A system for use in processing clinical data, comprising:
a display generator for initiating generation of data representing an image for display including,
an item of clinical data of a particular patient and
an image element enabling a user to at least one of, (a) select a suggested clinical significance ranking of said item of clinical data and (b) override said suggested clinical significance ranking with a user entered item; and
at least one repository incorporating information associating data identifying a user with a selected clinical significance ranking of said item of clinical data and with said clinical data item.

16. A system according to claim 15, including
a data processor for deriving said suggested clinical significance ranking of said item of clinical data from statistical analysis of a plurality of previously acquired clinical significance rankings of corresponding items of clinical data.

17. A method for use in processing clinical data, comprising the activities of:
initiating generation of data representing an image for display including,
an item of clinical data of a particular patient and
an image element enabling a user to enter data identifying a clinical significance ranking of said item of clinical data; and
storing information, associating data identifying a user with an entered clinical significance ranking of said item of clinical data and with said clinical data item, in at least one repository.

18. A method for use in processing clinical data, comprising the activities of:
initiating generation of data representing an image for display including,
an item of clinical data of a particular patient and
an image element enabling a user to enter data identifying a clinical significance ranking of said item of clinical data;
associating said user with an entered clinical significance ranking of said item of clinical data and with said clinical data item; and
storing, in a repository, information indicating said entered clinical significance ranking of said item of clinical data and said associated clinical data item and user.

19. A method for use in processing clinical data, comprising the activities of:
initiating generation of data representing an image for display including,
an item of clinical data of a particular patient and
an image element enabling a user to enter data identifying a clinical significance ranking of said item of clinical data;
determining a user category based on said user identification information and for associating said user category with an entered clinical significance ranking of said item of clinical data and with said clinical data item; and
storing, in a repository, information indicating said entered clinical significance ranking of said item of clinical data and said associated clinical data item and user category.

20. A method for use in processing clinical data, comprising the activities of:
initiating generation of data representing an image for display including,
an item of clinical data of a particular patient and
an image element enabling a user to enter data identifying a clinical significance ranking of said item of clinical data;
storing information associating data identifying a user with an entered clinical significance ranking of said item of clinical data and with said clinical data item, in at least one repository; and
initiating alteration of a task sequence of a healthcare worker in response to said entered clinical significance ranking of said item of clinical data.

21. A method for use in processing clinical data, comprising the activities of:
initiating generation of data representing an image for display including,
an item of clinical data of a particular patient and
an image element enabling a user to at least one of, (a) select a suggested clinical significance ranking of said item of clinical data and (b) override said suggested clinical significance ranking with a user entered item; and
storing information associating data identifying a user with a selected clinical significance ranking of said item of clinical data and with said clinical data item, at least one repository.
